(19) United States
(12) Patent Application Publication
(10) Pub. No.: US 2026/0285358 A1
(43) Pub. Date: Sep. 24, 2026

(54) SYSTEMS AND METHODS FOR DETECTING OCCLUDED OBJECTS

(71) Applicant: Torc Robotics, Inc., Blacksburg, VA (US)

(72) Inventors: Gerardas Skeberdis, Hickory Hills, IL (US); Xholjon Dede, Esslingen am Neckar (DE); Sebastian Dingler, Stuttgart (DE); Adam Schneider, Christiansburg, VA (US); Jayesh Dwivedi, Oakmont, PA (US); Nicholas Atanasov, Austin, TX (US)

(21) Appl. No.: 19/085,439

(22) Filed: Mar. 20, 2025

(51) Int. Cl. B60W 60/00; B60W 30/14; B60W 30/16; B60W 50/14; G06V 10/141; G06V 10/26; G06V 10/60; G06V 20/56

(52) U.S. Cl. CPC B60W 60/001; B60W 30/143; B60W 30/16; B60W 50/14; G06V 10/141; G06V 10/26; G06V 10/60; G06V 20/56; B60W 2300/14; B60W 2420/403; B60W 2554/402; B60W 2554/4041; B60W 2554/4042; B60W 2554/80

(57) ABSTRACT

An autonomous vehicle configured to detect occluded objects. The autonomous vehicle includes a processor in communication with a memory device, and sensors. The processor is programmed to: (i) receive optical data of optical phenomena adjacent the autonomous vehicle based upon analysis of sensor data from the sensors; (ii) analyze the optical data of the optical phenomena to determine that the optical phenomena corresponds to the presence of an object adjacent the autonomous vehicle, the object being occluded from a line of sight of the autonomous vehicle, the line of sight being defined at least in part by a trailer of the autonomous vehicle; (iii) change one or more driving behaviors of the autonomous vehicle based upon the determination of the presence of the occluded object; and (iv) control operation of the autonomous vehicle based upon the one or more changed driving behaviors.

### TECHNICAL FIELD

The field of the disclosure relates to autonomous vehicles and, in particular, to systems and methods for detecting occluded objects adjacent an autonomous vehicle.

### BACKGROUND OF THE INVENTION

In driving, an autonomous vehicle relies on the identification of various objects in the surrounding environment to determine how the autonomous vehicle is controlled. However, while driving, certain objects within the surrounding environment may be or become occluded from the autonomous vehicle's sensor-based vision system(s), such as a vehicle that is following closely behind a trailer that is attached to the autonomous vehicle.

Additional challenges exist in that it may be impractical and/or otherwise undesirable to locate sophisticated sensors on the trailer itself. For example, trailers are typically made by manufacturers that are different from manufacturers of tractors. Additionally, locating sophisticated sensors on the trailer may increase complexity, such as requiring additional integration/coordination between the autonomous vehicle and an attached trailer. Trailers may also suffer wear and tear, representing an increased risk of damage to the sensors if the sensors are located on the trailer. These issues may increase costs and/or maintenance.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomous vehicle configured to detect occluded objects. The autonomous vehicle includes at least one processor in communication with at least one memory device, and one or more sensors. The at least one processor is programmed to receive optical data of one or more optical phenomena adjacent the autonomous vehicle based upon analysis of sensor data from the one or more sensors of the autonomous vehicle. The at least one processor is further programmed to analyze the optical data of the one or more optical phenomena to determine that the one or more optical phenomena corresponds to the presence of an object adjacent the autonomous vehicle, the object being occluded from a line of sight of the autonomous vehicle, the line of sight being defined at least in part by a trailer of the autonomous vehicle. The at least one processor is yet further programmed to change one or more driving behaviors of the autonomous vehicle based upon the determination of the presence of the occluded object. The at least one processor is yet further programmed to control operation of the autonomous vehicle based upon the one or more changed driving behaviors.

In another aspect, an autonomy computing system of an autonomous vehicle for detecting occluded objects. The autonomy computing system includes at least one processor in communication with at least one memory device. The at least one processor is programmed to receive optical data of one or more optical phenomena adjacent the autonomous vehicle based upon analysis of sensor data from one or more sensors of the autonomous vehicle. The at least one processor is further programmed to analyze the optical data of the one or more optical phenomena to determine that the one or more optical phenomena corresponds to the presence of an object adjacent the autonomous vehicle, the object being occluded from a line of sight of the autonomous vehicle, the line of sight being defined at least in part by a trailer of the autonomous vehicle. The at least one processor is yet further programmed to change one or more driving behaviors of the autonomous vehicle based upon the determination of the presence of the occluded object. The at least one processor is yet further programmed to control operation of the autonomous vehicle based upon the one or more changed driving behaviors.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of the autonomous vehicle shown in FIG. 1;

FIG. 3 is an example illustration of optical phenomena detection according to one embodiment of the present disclosure;

FIG. 4 is an example illustration of optical phenomena detection according to another embodiment of the present disclosure;

FIG. 5 is an example illustration of optical phenomena detection according to yet another embodiment of the present disclosure;

FIG. 6 is a flow diagram of a method of operations performed by an autonomy computing system shown in FIG. 2;

FIG. 7A is a flow diagram of a process performed by the autonomy computing system shown in FIG. 2 for certain embodiments of the present disclosure;

FIG. 7B is a flow diagram of a process performed by the autonomy computing system shown in FIG. 2 for other embodiments of the present disclosure; and

FIG. 8 is a block diagram illustrating an example configuration of an autonomy computing device according to one embodiment of the present disclosure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

As described herein, the disclosed systems and methods include sensors of the autonomous vehicle, such as optical sensors, being positioned on/in the autonomous vehicle and configured to detect optical phenomena such as shadows cast as a result of light from various light sources as well as light reflections from light sources. Light sources may include environmental light sources, which may include natural environmental light sources such as sunlight and moonlight, as well as artificial environmental light sources within a driving environment such as street lighting, highway lighting, vehicle headlamps, etc. A shadow corresponding to an object may be determined based on sensor data indicating different light intensities, colors, shapes, sizes, and/or edges of or associated with the shadow. Additionally, light sources may include dedicated light sources positioned on/in the autonomous vehicle and configured to emit targeted light to target areas such as a portion of a road/highway surface, where reflections of the light emitted from the dedicated light sources off the road/highway surface are able to be detected by the sensors and corresponding sensor data utilized for detection purposes. For example, a target area may be a blind spot of the autonomous vehicle. A dedicated light source may utilize either or both of light in the visible spectrum and/or light in the non-visible spectrum.

An object such as a vehicle travelling in the blind spot of the autonomous vehicle may effectively be occluded from perception by the autonomous vehicle. An occluded object such as a vehicle in a blind spot of the autonomous vehicle nevertheless still casts a shadow when various light sources are present, and it is possible to utilize light in the visible and/or non-visible light spectrums, in addition to dedicated light sources, to detect the occluded object and determine properties of the occluded object. Dedicated light sources may include additional components such as mirrors to help guide/control light emitted from the dedicated light sources. Light from dedicated light sources may be reflected off passive mirrors (e.g., mirrors that are adjusted/moved manually) or active mirrors (e.g., mirrors that are adjusted/moved via computer control) that are installed on the autonomous vehicle to disperse the light into/onto the driving environment including the road/highway surface.

The autonomous vehicle has memory to store optical data obtained by the various sensors, and at least one processor to process the (e.g., optical) data and identify characteristics of shadows such as shadow locations, based on various factors such as sun angle and timing of emitted light (e.g., including aspects relating to modulation, frequency, etc.). Additionally, the processor is used to analyze light reflections and corresponding illumination timing data to compute the estimated location, velocity, and/or size of the occluded object based the light reflections, as well as based on other factors such as cast shadow size and location over time. A trailer of the autonomous vehicle may be referred to herein as an “occlusion source,” and a vehicle following behind (or on the side of) the trailer may be referred to herein as an “occluded object.”

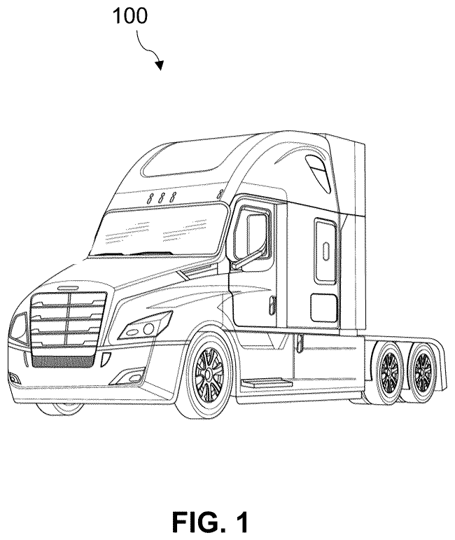

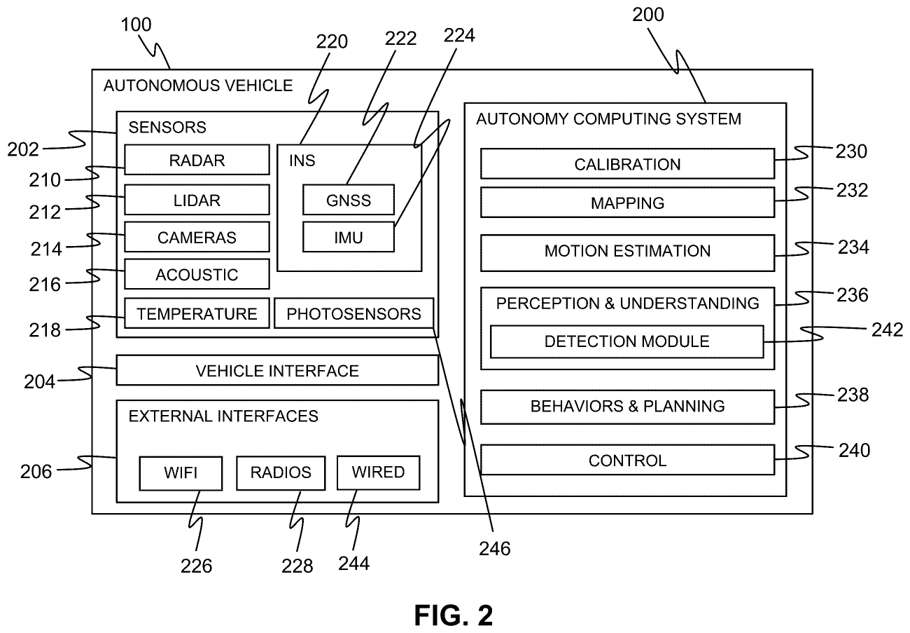

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras'FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. Radar sensors 210 may include short-range radar (SRR), mid-range radar (MRR), long-range radar (LRR), or ground-penetrating radar (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

Sensors 202 may also include photosensors 246, such as photoemitters and/or photodetectors, as described herein. Photosensors 246 may emit and/or detect light in various wavelength ranges. Photosensors 246 may include separate photoemitters and photodetectors, and/or integrated photoemitters and photodetectors that may be integrally packaged as a common unit.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a detection module 242. Detection module 242, for example, may be embodied within another module, such as perception and understanding module 236, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

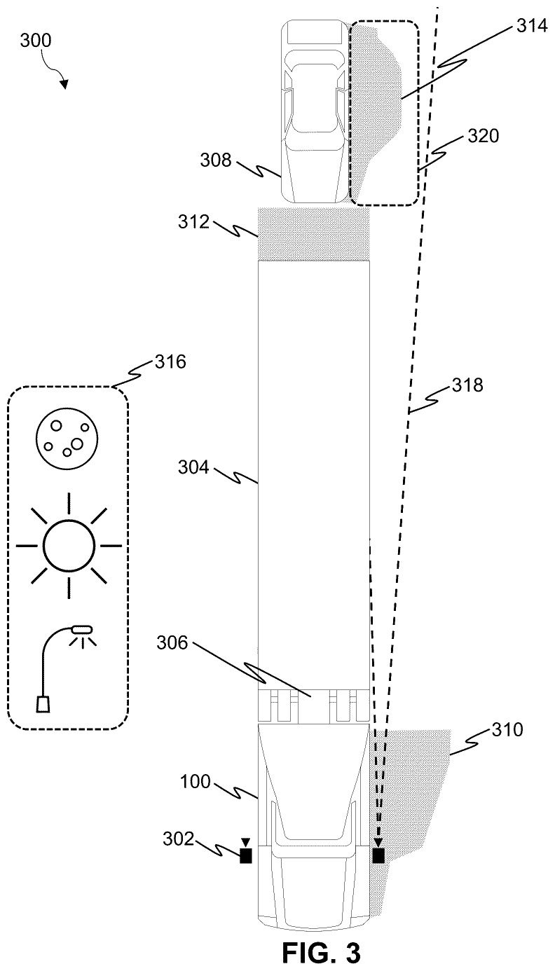

Detection module 242 may perform one or more tasks including, but not limited to, analyzing sensor data of detected optical phenomena such as light (including light of different intensities and reflections) and shadows, and ascertaining an object corresponding to the detected optical phenomena. Determinations and/or analysis output from detection module 242 may be utilized to update or change a travel path and/or change driving behaviors of autonomous vehicle 100 in a live driving session based upon the detected optical phenomena and the corresponding object. Detection module 242 may transmit data corresponding to the detected optical phenomena and/or object to other modules of the autonomy computing system 200, mission control, or external databases, or each. Tasks performed by detection 242 are described in more detail via FIGS. 3-9 (described later), for example.

A plurality of rules and/or algorithms may be stored within a memory of autonomy computing system 200 in connection with its various modules such as for detection module 242. These rules and/or algorithms include but are not limited to object detection rules and/or behavior determination rules. Object detection rules and/or algorithms may be configured to determine a class of an occluded object based on characteristics determined from analysis of a shadow corresponding to the occluded object. For example, a class of an occluded object may include a vehicle (e.g., as compared to a non-vehicle) and sub-classes such as different types of vehicles (e.g., trucks, mid-size vehicles, etc.). Classification may also include classification based on passenger vehicles versus commercial vehicles, etc. The object detection rules and/or algorithms may also be configured to correlate positions of light sources, vehicle positions, environmental sensing, and illumination timing.

Behavior determination rules and/or algorithms may be configured to both update and/or change an operational behavior of autonomous vehicle 100 and determine a risk associated with an occluded object driving behind or adjacent to autonomous vehicle 100. For example, a risk determination may be based on made a current speed of autonomous vehicle 100 relative to a determined speed of the occluded object and/or a determined distance between the occluded object and a trailer attached to autonomous vehicle 100. Risk determination rules and/or algorithms may be configured to determine risk according to various factors, including but not limited to a risk of collision, etc. Autonomous vehicle 100 may change on or more driving behaviors based on a given risk determination. For example, if a risk of collision is determined, the speed of autonomous vehicle 100 may be increased to increase an amount of spacing from an object. Risk may be associated with a risk score threshold, where a triggering of the risk score threshold causes an action or behavior to occur. The risk score threshold may be based on various weights attributed to various factors (e.g., speed, distance, etc.) and may represent a composite score of the weighted factors. As described herein, the various rules and/or algorithms may be set and tested based on analysis of real-world log data including sensor data of autonomous vehicles and/or any other types of vehicles. Additionally, or alternatively, simulation data may be utilized to generate prediction models and forward scenarios. This may include predictions relating to the vehicle behind autonomous vehicle 100, such as predictions relating to a lane change of the vehicle behind autonomous vehicle 100, speed changes of the vehicle behind autonomous vehicle 100, location changes of the vehicle behind autonomous vehicle 100, etc.

Autonomy computing system 200 of autonomous vehicle 100 may be completely autonomous (fully autonomous), semi-autonomous, or with any level of autonomy. In one example, autonomy computing system 200 can operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

FIG. 3 is an example illustration of an optical phenomena detection configuration 300 according to one embodiment of the present disclosure. More specifically, FIG. 3 depicts a shadow detection scenario where shadows resulting from an environmental light source such as a natural light source (e.g., the sun or the moon) and/or an artificial light source (e.g., highway lighting) are able to be detected and analyzed by autonomous vehicle 100 to determine occluded objects such as a vehicle driving in a blind spot of autonomous vehicle 100. For example, during a driving trip of autonomous vehicle 100, and depending on the time of day, time of year, cloud cover, travel direction, orientation of vehicles, orientation of a natural light source (e.g., the sun or the moon), etc., shadows corresponding to vehicles travelling on the road/highway may be present on the road surface, and these shadows may be able to be detected and analyzed by autonomous vehicle 100 as described herein. The presence (or absence) of vehicles and/or other properties and features of vehicles based on their shadow may also be able to be determined. This is particularly useful for vehicles that may be in a blind spot of autonomous vehicle 100 or otherwise occluded from autonomous vehicle 100.

As shown in FIG. 3, autonomous vehicle 100 may include a plurality of sensors 302 and a trailer 304 attached to autonomous vehicle 100 via hitch 306. Travelling closely behind trailer 304 may be a vehicle 308. Based on the position of a natural light source such as the sun or the moon, and/or an artificial light source such as highway lighting, a shadow 310 may be cast relative to autonomous vehicle 100, a shadow 312 may be cast relative to trailer 304, and a shadow 314 may be cast relative to vehicle 308. Sensors 302 may be configured to generally detect shadows, and in live driving sessions, detect at least shadow 314 of vehicle 308.

Depending on the orientation of an environmental light source 316 (e.g., the location of the sun or the moon), the resulting shadows 310, 312, and 314 may take various forms relative to their respective objects (e.g., autonomous vehicle 100, trailer 304, vehicle 308). For example, in scenarios where environmental light source 316 is primarily located at one side or the other of an object, the shadow may very closely match a shape of the corresponding object. In other scenarios where environmental light source 316 is, for example, directly above an object, a shadow may barely be present and/or may match less closely to a shape of the corresponding object. As such, depending on the orientation of environmental light source 316, the amount of meaningful information that may be able to be extracted from a shadow may vary depending on the presence and characteristics of the shadow. In configuration 300, at least because environmental light source 316 is at one side, shadow 314 of vehicle 308 may have an overall form, including defined edges, that closely matches the shape of vehicle 308. The characteristics of the shadow form, edges, etc. of shadow 314 may be able to be detected to help identify a class of the object that vehicle 308 belongs to, such as a class of object corresponding to vehicles, and more particularly a class corresponding to mid-size vehicles.

Sensors 302 may have an associated FOV 318 that may be focused toward the body of trailer 304 and more specifically to a rear of trailer 304 as well as to a target area 320 of a surface such as a road/highway surface. Target area 320 may be an area including at least shadow 314 of vehicle 308. Sensors 302 may be configured to detect shadow 314 in target area 320, and sensor data obtained by sensors 302 may be analyzed to extrapolate information from shadow 314 that can be used to determine properties of the object (e.g., vehicle 308) that caused shadow 314 to be cast. The detection of shadow 314 may be based upon a variety of factors, including but not limited to visual and/or other optical properties of the shadows that are capable of being ascertained by sensors 302, such as light intensity differences within target area 320 and/or shape characteristics of shadow 314 as described herein. For example, shadow 314 may necessarily be a darker color than other portions of target area 320 not covered in a shadow, and the detected differences in color may be utilized to make downstream determinations regarding properties of the shadow and/or of the object that cast the shadow.

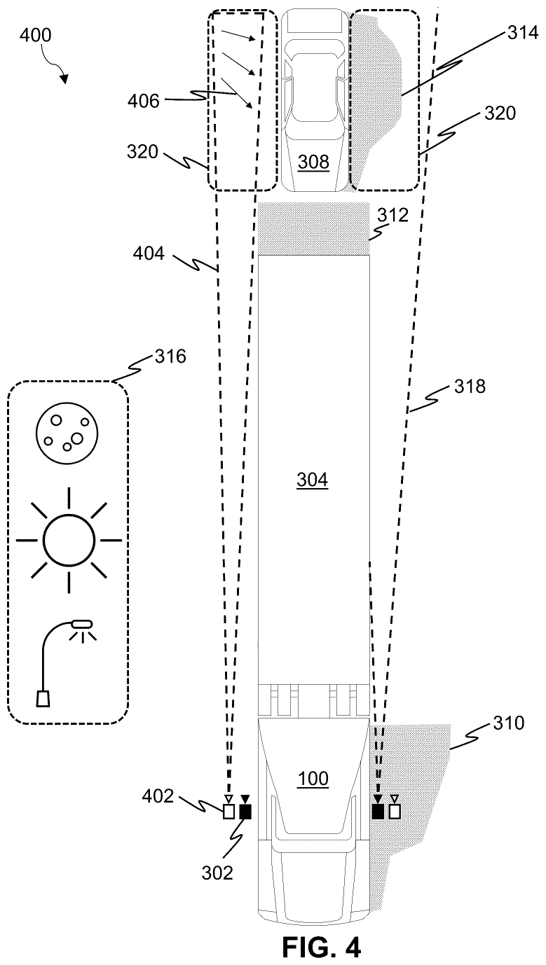

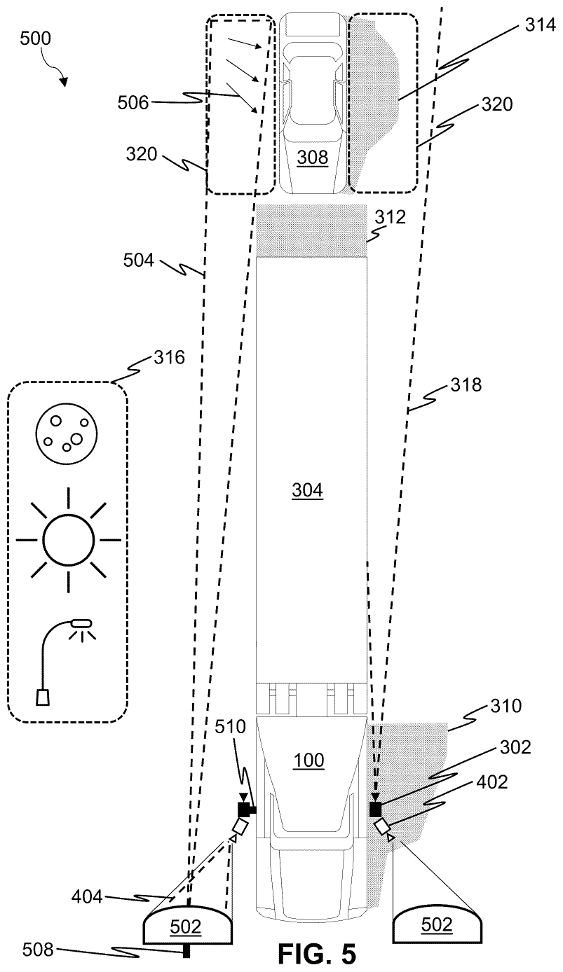

While shadow 314 of vehicle 308 is of particular interest and importance in ascertaining an object such as vehicle 308 that may be occluded due at least in part to trailer 304 acting as an occlusion source, sensors 302 may additionally be configured to detect shadow 310 of autonomous vehicle 100 and/or shadow 312 of trailer 304. In some embodiments, shadow 310 of autonomous vehicle 100 and/or shadow 312 of trailer 304 may be analyzed and used as a frame of reference to assist in determining the relative position of vehicle 308 to autonomous vehicle 100 and/or to trailer 304, and/or to determine or otherwise derive other relationships relating to distance between objects, angles of light and/or shadows, speed, etc. For example, shadows 310 and 312 may be utilized in connection with illumination timing, such as differences in emitted and received light as described herein in connection with FIGS. 4 and 5, for example. In other embodiments, one or both of shadow 310 of autonomous vehicle 100 and/or shadow 312 of trailer 304 and the corresponding data thereof may be intentionally disregarded to focus only on shadow 314, or autonomous vehicle 100 may consider a combination of shadows 310, 312, and/or 314 to analyze/not analyze.

In operation, sensors 302 at each side of autonomous vehicle 100 may operate continuously, periodically, and/or based on an external trigger event such as a cue from an output of a different sensor. Sensors 302 may operate in a designated order, such as one side at a time, both sides at once, etc. For example, this may include alternating from side to side, scanning sensors 302 across target areas, etc. In some embodiments, progressive scanning may be utilized.

In one embodiment, one or more of sensors 202 of autonomous vehicle 100 may be implemented as sensors 302 and installed at various locations of the body of autonomous vehicle 100, including but not limited to a first side and a second side of autonomous vehicle 100 as shown in FIG. 3. For example, RADAR sensors 210, LiDAR sensors 212, cameras 214, and/or photosensors 246 may be implemented as sensors 302. Photosensors 246 may include photoemitters capable of emitting light within designated wavelength ranges and/or photodetectors capable of detecting light within designated wavelength ranges.

In the case of sensors 302 including RADAR sensors 210, data obtained by RADAR sensors 210 may be able to infer the presence of a shadow based on the presence/absence of reflected signals. For example, if an object is present, RADAR sensors 210 should receive reflected signals back from the object, indicating the presence of an object. Similarly, if no signal reflections are received, this may indicate that no object is present. By comparing the data of received and non-received reflection signals, an inference may be able to be made as to the presence of an object and therefore also a shadow (or the presence of an obstruction blocking the radar signal).

In the case of sensors 302 including LiDAR sensors 212, when an object blocks laser pulses emitted from LiDAR sensors 212, a corresponding “shadow” may be created in the LiDAR sensor data, which can be detected and analyzed. For example, a point cloud generated by LiDAR sensors 212 may be indicative of a blocked or out of range object and the data of the point cloud may reflect such.

In the case of sensors 302 including cameras 214, cameras 214 may be configured to capture a series of static images, frames of a video, etc. of an area such as target area 320 and compare the images and/or frames to determine if a shadow is present. For example, analysis via (e.g., grayscale) color conversion techniques and/or other techniques relating to light intensity (e.g., brightness, darkness) may be utilized to determine the presence of a shadow. Algorithms such as edge detection algorithms may be utilized to identify sharp changes in light intensity, which may indicate the presence of shadows and/or details of the shape of the shadow itself. Additionally, other techniques such as differentiating between light and dark areas in an image/frame may help isolate the shadow from the rest of the image/scene. Shadow detection algorithms may also be utilized, including but not limited to blob detection, morphological operations, noise removal, and/or contour detection. For example, blob detection may be utilized to identify connected dark regions in the image, and contour detection may be utilized to outline the shape of the shadow, which may provide precise information about the size and/or location of the shadow.

In the case of sensors 302 including photosensors 246, sensors 302 may be implemented as paired photoemitters and photodetectors that emit and detect light such as visible light and/or non-visible light such as infrared (IR) light and/or ultraviolet (UV) light. For IR light, IR sensors may be configured for emitting/detecting (i) Near-Infrared (NIR), which may generally range from about 700 nm to 1,400 nm, (ii) Mid-Infrared (MIR), which may generally range from about 1,400 nm to 3,000 nm, and/or (iii) Far-Infrared (FIR), which may generally range from about 3,000 nm to 1 mm. The NIR/MIR/FIR divisions described herein are not limiting and may vary in terms of which wavelengths are included within each division, and/or the minimum and maximum wavelengths in each division. For example, optical sensors may operate in accordance with standards such as ISO 20473, which may categorize the wavelengths included within each of NIR/MIR/FIR differently than other categorizations of NIR/MIR/FIR. For example, for a given photosensor pair, the photoemitter may emit FIR light and the photodetector may detect FIR light, and detecting via the photodetector may include detection of reflections of the emitted FIR light from one or more surfaces such as a road/highway surface and/or a surface of the occluded object such as vehicle 308. Photosensors 246 and/or any related software may be tuned, for example, via specialized filters, coatings, gratings, and/or via signal processing algorithms, to emit and/or detect light in a tailored manner that avoids emitting certain wavelengths and likewise avoids and/or otherwise disregards detection of certain wavelengths, for example to reduce false positives and enhance accuracy and reliability in sensing. In general, the type(s) of light utilized may be selected to reduce potential interference with other sources, especially within the context of highway driving.

In one embodiment, sensors 302 may only include photodetectors tuned for detecting shadows resulting from environmental light source 316. In other embodiments, sensors 302 may include photosensors 246 that include both a photoemitter and a photodetector, where light emitted from the photoemitter may generally be emitted in a field of emission (FOE) that has a shape that is the same as or similar to FOV 318. When sensors 302 include photosensors 246 that include both a photoemitter and a photodetector, the photodetector may be configured to both detect shadows resulting from environmental light source 316 and/or light reflections from the photoemitter. These photodetection aspects are described in more detail in connection with FIG. 4, for example.

FIG. 4 is an example illustration of an optical phenomena detection configuration 400 according to another embodiment of the present disclosure. More specifically, FIG. 4 depicts a shadow and reflection detection scenario where autonomous vehicle 100 includes one or more dedicated light sources 402 to provide artificial light that is utilized as part of the detection and analysis systems and methods described herein. Common elements from FIG. 3 that appear in FIG. 4 are not explained again in connection with FIG. 4. While dedicated light source 402 is shown separate from sensors 302, dedicated light source 402 may be integrated with sensors 302, or otherwise operatively connected with sensors 302.

Dedicated light source 402 may be implemented as a light/photoemitter that emits light such as visible light and/or non-visible light such as IR light and/or UV light as described herein. Emitted light 404 from dedicated light source 402 may be emitted within a defined FOE that may generally be shaped the same as or similar to emitted light 404 in FIG. 4, including a certain width and depth (e.g., range). Reflections 406 of emitted light 404 may occur, such as from emitted light 404 reflecting off a road/highway surface upon which autonomous vehicle 100 is driving. Reflections 406 within target area 320 may be detected within FOV 318 of sensors 302. Reflection data corresponding to reflections 406 may be analyzed by detection module 242 to make determinations as to the occluded object (e.g., vehicle 308).

Timing calculations such as illumination timing may be utilized in connection with reflections 406 to ascertain distance, speed, and other parameters of vehicle 308. Illumination timing may include a time difference between emission of light pulses from dedicated light source 402 and receipt of reflections 406 by sensors 302, and may be utilized to make a plurality of calculations and/or determinations, such as relating to relative speed, distance, etc. of autonomous vehicle 100 and vehicle 308. Dedicated light source 402 may be used in combination with the detections associated with environmental light source(s) 316 such as sunlight, highway lights/lamps, etc., as described herein, or dedicated light source 402 may be utilized individually without factoring in detections resulting from environmental light sources 316.

Some of the benefits of optical phenomena detection configuration 400 include increased control of light and the type of light used in connection with the detection and analyzing systems and methods described herein, including the ability to generate known pulse timings and use the timings to make a plurality of timing-based determinations as described herein. For example, compared to relying only on shadows resulting from light from environmental light source 316 such as in certain embodiments relating to FIG. 3, dedicated light source 402 may be controlled by autonomy computing system 200 and its modules to emit pre-defined light to a target area 320. The use of dedicated light source 402 also introduces the option for duality in detection, such as using sensors 302 to detect shadows on one side of autonomous vehicle 100, and using reflections 406 on the other side of autonomous vehicle to extract aspects on a non-shadow side of vehicle 308. For example, with respect to FIG. 4, when shadow 314 is on one side of vehicle 308, information to be gleaned from the other side of vehicle 308 can be analyzed by way of reflections 406. Detection and analysis of data resulting from each side of vehicle 308 may be conducted one side at a time, simultaneously, or staggered, for any variety of reasons. For example, using a one side at a time approach may be advantageous when using artificial light such as from designated light sources 402, at least because the results obtained for one side can be used to corroborate results from the other side. The combined data from each side may be able to paint a “fuller” picture of vehicle 308, including size, shape, speed, type of vehicle, distance from trailer 304, etc. Also, in some embodiments, and depending on the particular driving scenario and driving environment, both shadow and light reflection detection can be performed on each side of autonomous vehicle 100. The use of dedicated light sources 402 and the data obtained therefrom may increase confidence in the resulting determinations, at least because the light from dedicated light sources 402 is known and pre-defined. For example, the use of dedicated light sources 402 may provide a high confidence level that an occluded object is present.

FIG. 5 is an example illustration of an optical phenomena detection configuration 500 according to yet another embodiment of the present disclosure. More specifically, FIG. 5 depicts a shadow and reflection detection scenario where autonomous vehicle 100 includes one or more mirrors 502 used in conjunction with dedicated light sources 402 to focus, direct, and/or otherwise beam form artificial light emitted from dedicated light source 402. Mirror 502 and dedicated light source 402 may be utilized as part of the detection and analysis systems and methods described herein. Common elements from FIGS. 3 and 4 that appear in FIG. 5 are not explained again in connection with FIG. 5. Mirrors 502 are shown in an exaggerated size in FIG. 5 for discussion and illustration purposes.

Emitted light 404 from dedicated light source 402 may be aimed at mirror 502. Mirror 502 may be concave, convex, or any other mirror type and/or shape sufficient to provide the desired dispersion of emitted light 404 in the manner shown in FIG. 5. Dispersed light 504 from mirror 502, also referred to as mirror-directed light, may be dispersed at a defined field of dispersion (FOD) that corresponds to properties of the type of mirror used for mirror 502, including the FOD having a certain width and depth (e.g., range). Reflections 506 of dispersed light 504 from mirror 502 may occur, such as from dispersed light 504 reflecting off a road/highway surface upon which autonomous vehicle 100 is driving, the same as or similar to reflections 406. Reflections 506 may be detected within FOV 318 of sensors 302. Reflection data corresponding to reflections 506 may be analyzed by detection module 242 to make determinations as to the occluded object (e.g., vehicle 308), including with respect to illumination timing as described herein. With respect to timing based calculations, the time it takes emitted light 404 to hit mirror 502 may need to be accounted for in calculations.

Mirror 502 and dedicated light source 402 may be used in combination with the detections associated with environmental light sources 316 such as sunlight as described herein, or mirror 502 and dedicated light source 402 may be utilized individually without regard for detections associated with environmental light sources 316. While shown as separate in FIG. 5, dedicated light source 402 and mirror 502 may alternatively be integrated, such as part of an integral package. In some embodiments, sensors 302, dedicated light source 402, and/or mirrors 502 may be part of a unitary sensor device or assembly.

Some of the benefits of optical phenomena detection configuration 500 include increased control of light used in connection with the detection and analyzing systems and methods described herein. For example, mirrors 502 may be able to better control and direct emitted light 404 than dedicated light source 402 alone. In one example, if autonomous vehicle 100 executes a turn, and trailer 304 trails behind autonomous vehicle 100 during the turn, trailer 304 may block certain viewpoints that were previously viewable, at least until the orientation of trailer 304 again matches the orientation of autonomous vehicle 100 (e.g., once the turn is completed). Mirrors 502 may be adjusted to account for and/or offset issues experienced in such a turn situation by re-directing emitted light 404 as mirror-directed light (e.g., 504) to account for the various angles present during the turn maneuver. As described herein, mirrors 502 may be movable/adjustable to further enhance custom focusing and/or beam forming of light. Mirrors 502 may therefore be beneficial in reducing new blind spots that may be induced when executing maneuvers such as turns. For example, a turn may be executed by autonomous vehicle 100 at an intersection, and mirrors 502 may be utilized such that dispersed light 504 continues toward a target area 320 regardless of the turn being executed. Additionally, mirrors 502 may be adjusted to not only “look” one car behind, but to “look” two cars behind.

Sensors 302, dedicated light source 402, and/or mirrors 502 may be paired in tandem for use at each side of autonomous vehicle 100. For example, as shown in FIG. 4, there may be a set 302/402 on each side of autonomous vehicle 100. Similarly, as shown in FIG. 5, there may be a set 302/402/502 on each side of autonomous vehicle 100. For example, mirrors 502 may be located near the headlight area of autonomous vehicle 100 to aid in the redirection of emitted light 404 from artificial light source 402. However, the location of sensors 302, dedicated light source 402, and/or mirrors 502 need not be limited to sides of autonomous vehicle 100 such as a left or right side. For example, sensors 302, dedicated light source 402, and/or mirrors 502 may additionally, or alternatively, in whole or in part, be located on a top portion of autonomous vehicle 100.

Additionally, each of sensors 302, dedicated light source 402, and/or mirrors 502 may be attached to a movable element 508 such as a movable arm and/or other extension device 510 such as an extension rod/arm that can be controlled by autonomous vehicle 100 to physically adjust a position of sensors 302, dedicated light source 402, and/or mirrors 502. Such adjustment may include changing an angle of mirror 502, extending light source 402 outward from the body of autonomous vehicle 100, etc. These adjustments may be useful in changing an FOV and/or FOE associated with any of sensors 302 and/or dedicated light source 402, and/or changing beam forming by mirrors 502 and/or a focal point of light associated with dedicated light source 402 and/or mirrors 502 and any corresponding FOD. While movable element 508 is only shown in connection with mirror 502 in FIG. 5 and extension device 510 is only shown in connection with sensor 302, each of sensor 302, dedicated light source 402, and/or mirror 502 may be configured with movable element 508 and/or extension device 510 for the purposes described herein. For example, movable element 508 may be actuated in a turning scenario to ensure that desired FOEs/FOVs/FODs and corresponding detection capabilities are maintained during turning of autonomous vehicle 100 and trailer 304. Movable element 508 and/or extension device 510 may afford additional viewing points, viewing angles, emission angles, detection angles, etc. For example, movable element 508 and/or extension device 510 may improve the ability of sensors 302, dedicated light sources 402, and/or mirrors 502 to detect shadows/light reflections and/or emit/direct light even in scenarios such as when autonomous vehicle is executing a turn, such as at an intersection, as described herein. Further, at an intersection, the adjustment/extension afforded by movable element 508 and/or extension device 510 may improve the ability and ranges of sensors 302, dedicated light sources 402, and/or mirrors 502 obtain a more accurate mapping of the driving environment at the intersection (e.g., how many other vehicles are behind trailer 304, which lanes other vehicles are in, etc.). In some embodiments, operating parameters of the one or more sensors 302, light sources 402 and/or associated devices of light sources may be adjusted based on the current driving scenario of autonomous vehicle 100. For example, the level of tracking the range behind the autonomous vehicle 100 for occluded objects may be adjusted based on the current driving scenario. When autonomous vehicle 100 is driving in an intersection scenario, the range may be closely tracked because vehicles are more likely behind autonomous vehicle 100 and speed changes of vehicles are more frequent than a highway scenario.

Various configurations of different sensor types may be utilized together to take advantages of the strengths of each and/or minimize the weaknesses of each. For example, the inference of a shadow determined via RADAR sensors 210 may be utilized in combination with point clouds from LiDAR sensors 212 which may be compared against images/videos from cameras 214 and/or data from photosensors 246 to arrive at a composite determination based on data from a plurality of different sensor types and their corresponding data. Such varied usage of plural sensor types may be useful in improving overall reliability of resulting determinations and/or preventing false positives and/or other inaccuracies, for example as compared with relying on data from just one type of sensors. Various operating parameters of sensors 302, dedicated light sources 402, and/or mirrors 502 may be modified based on the driving environment, driving scenarios, types or amounts of occluded objects, etc. Modifying operational parameters may include changing a focal length and/or direction of emitted light from dedicated light sources 402 such as via mirrors 502, changing a width of a FOV/FOE/FOD, changing a physical position of sensors 302, dedicated light sources 402, and/or mirrors 502, etc.

The sensor data from the various sensor types may be used in conjunction with artificial intelligence tools such as machine learning tools and/or computer vision tools to improve detection accuracy and/or accuracy in analyzing the sensor data as described herein. For example, a machine learning model may be able to be trained using labeled images from cameras 214 where shadows have been annotated, to recognize and detect shadows in new images. In some driving scenarios, vehicle 308 may change status from occluded to visible, and so on and so forth. For example, vehicle 308 may change lanes and become visible, and then change lanes again and become occluded. In such scenarios, autonomous vehicle 100 may determine via the sensor data that vehicle 308 is or is not occluded. If vehicle 308 is determined to no longer occluded, autonomous vehicle may cease tracking vehicle 308 as an occluded object and instead track vehicle 308 using other detection/tracking protocols. If vehicle 308 becomes re-occluded object, then occluded object tracking as described herein may be re-initiated. Autonomous vehicle 100 may therefore hop between detection protocols depending on a visible/occluded determination for any given object. Predictive motion techniques as described herein may be utilized to assist in predicting and/or determining changes between occluded to visible and vice versa. Further, tracking vehicle 308 switching between being visible and being occluded is advantageous in increasing the accuracy in identifying occluded objects.

Additionally, determinations made from the analysis of shadows/light reflections may be communicated in various ways. Beyond merely generating control signals to change an operational behavior of autonomous vehicle 100 based on determinations relating to the occluded object, visual and/or audible indicators may be generated inside the cab of autonomous vehicle 100. For example, in the case where a host/human driver is present inside the cab, LEDs lights and/or other displays and sounds may be utilized to convey that braking, accelerating, etc. has been triggered in response to a detected occluded object. Additionally, external indicators configured and intended to be perceived by a driver of vehicle 308 may be utilized. For example, autonomous vehicle 100 may be controlled to perform an alert maneuver or display an alert indicator to one or more occupants of vehicle 308 such as the driver of vehicle 308. An alert maneuver may include a “pumping of the brakes” of autonomous vehicle 100 (e.g., braking spurts) and function as a warning to the occupants. An alert indicator may include an audible or visible alert, such as a horn of autonomous vehicle 100 blowing or an LED array of autonomous vehicle 100 being activated in a noticeable color such as red. The use of alerts may increase safety.

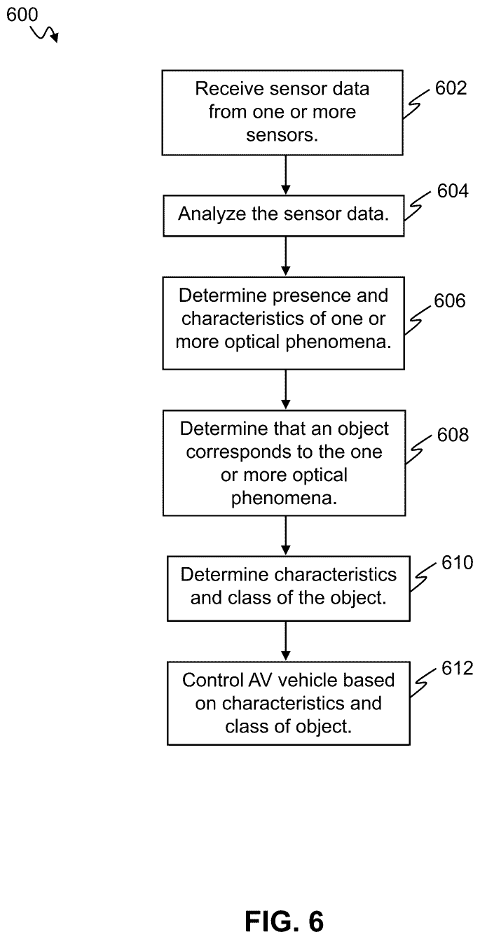

FIG. 6 is a flow diagram of a method of operations 600 performed by autonomy computing system 200. Method 600 includes receiving 602 sensor data from or more sensors such as sensors 202, as described herein. More specifically, this may include data from sensors 302. Method 600 further includes analyzing 604 the sensor data, as described herein. For example, this may include parsing the data from sensors 302 for data corresponding to light intensities, reflections, etc., as described herein. Method 600 yet further includes determining 606 the presence and characteristics of one or more optical phenomena, as described herein. For example, this may include determining, based on corresponding rules and/or algorithms, that the light intensity data is indicative of a shadow being present, as well determining parameters of the shadow, such as size, shape, etc. Method 600 yet further includes determining 608 that an object corresponds to the one or more optional phenomena. This may include referencing rules and/or utilizing algorithms to determine objects that correspond to the determined shadow size, shape, etc. Method 600 yet further includes determining 610 characteristics of the object. This may further include edge detection analysis as described herein, to help further ascertain the object, such as ascertaining a type or class of vehicle based on the size, shape, edge profiles. From the determined vehicle type/class, other information such as a weight profile of the vehicle type/class may be obtained. For example, reference may be made to a look-up table associated with the rules to find table entries of certain sizes, shapes, edge parameters, etc., linked to certain vehicle classes. Downstream determinations may then be made based, for example, on a determined weight profile of the occluded vehicle, which may be useful in a driving environment to ensure proper spacing is kept between trailer 304 and an occluded vehicle (e.g., 308) having the weight profile determined from the look-up table. For example, autonomous vehicle 100 may be controlled to increase a speed in order to keep safe spacing between trailer 304 and vehicle 308 based at least in part on the actual speed of vehicle 308 and/or weight parameters from the associated class of vehicle 308. Method 600 yet further includes controlling 612 the autonomous vehicle (AV) based on the characteristics and class of the object. This may include changing one or more behaviors of autonomous vehicle 100, such as increasing a speed of autonomous vehicle 100, if, for example, the object (e.g., vehicle 308) is determined to be too close in proximity to the rear of trailer 304 (e.g., a “tailgating” scenario). As one example of controlling 612, emitted light 404 from dedicated light source 402 is emitted in a direction toward trailer 304, and reflection data associated with reflections 406 is analyzed to determine properties of the occluded object (e.g., vehicle 308) as described herein. If a determined property indicates an unsafe following distance of the occluded object (e.g., vehicle 308) relative to trailer 304, a determination may be made by the modules of autonomy computing system to change one or more driving behaviors of autonomous vehicle 100, based at least in part on the determined properties (e.g., unsafe following distance) of the occluded object (e.g., vehicle 308). In this example, controlling 612 may include changing a speed of autonomous vehicle 100 to increase a distance between autonomous vehicle 100 and the occluded object (e.g., vehicle 308).

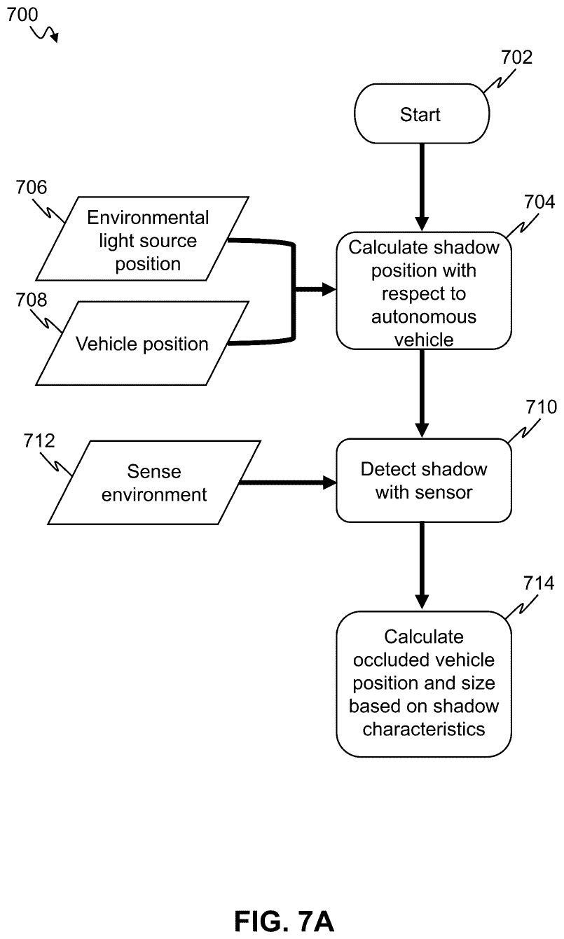

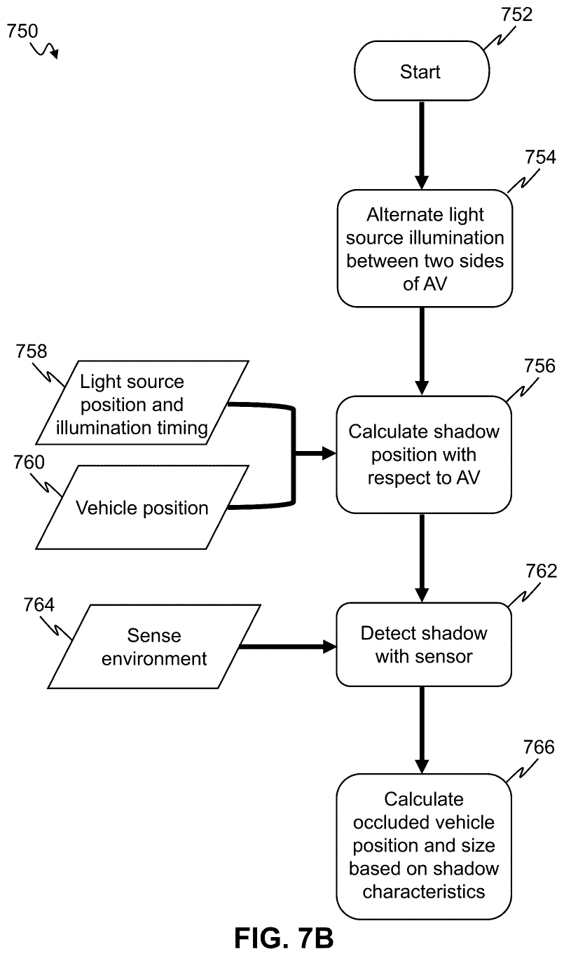

FIG. 7A is a flow diagram of a process 700 performed by autonomy computing system 200 for embodiments corresponding to FIG. 3, where autonomous vehicle 100 may include sensors 302 but not include any dedicated light sources 402 and/or mirrors 502. Process 700 includes a start block 702. Process 700 further includes a calculate block 704 for calculating a shadow position with respect to autonomous vehicle 100. Process 700 yet further includes input block 706 as an input to calculate block 704, inputting environmental light source position data. Process 700 yet further includes input block 708 as an input to calculate block 704, inputting vehicle position data. For example, vehicle position data may also utilize GPS data of autonomous vehicle 100 in addition to other position data such as a position of vehicle 308 as described herein. Process 700 yet further includes detect block 710 for detecting the shadow (e.g., 314) with one or more sensors (e.g., 202). Process 700 yet further includes input block 712 as an input to detect block 710, inputting sense data from the environment, such as sense data from the various sensors. Process 700 yet further includes calculate block 714, calculating an occluded vehicle position and size based on characteristics of the shadow.

FIG. 7B is a flow diagram of a process 750 performed by autonomy computing system 200 for embodiments corresponding to FIG. 4 and/or FIG. 5, where autonomous vehicle 100 may include sensors 302, dedicated light sources 402, and/or mirrors 502. Process 750 includes a start block 752. Process 750 further includes an alternate block 754, alternating light source illumination between two sides of autonomous vehicle 100 as described herein. Process 750 yet further includes calculate block 756, calculating a shadow position (e.g., of shadow 314) with respect to autonomous vehicle 100. Process 750 yet further includes input block 758 as an input to calculate block 756, inputting light source position data and illumination timing data as described herein. For example, speed, distance, etc. may be determined based on time differences in emitted/received light as described herein. Process 750 yet further includes input block 760 as an input to calculate block 756, inputting vehicle position data as described herein. Process 750 yet further includes detect block 762, detecting the shadow with one or more sensors as described herein. Process 750 yet further includes input block 764 as an input to detect block 762, inputting sense data from the environment as described herein. Process 750 yet further includes calculate block 766, calculating an occluded vehicle position and size based on characteristics of the shadow as described herein.

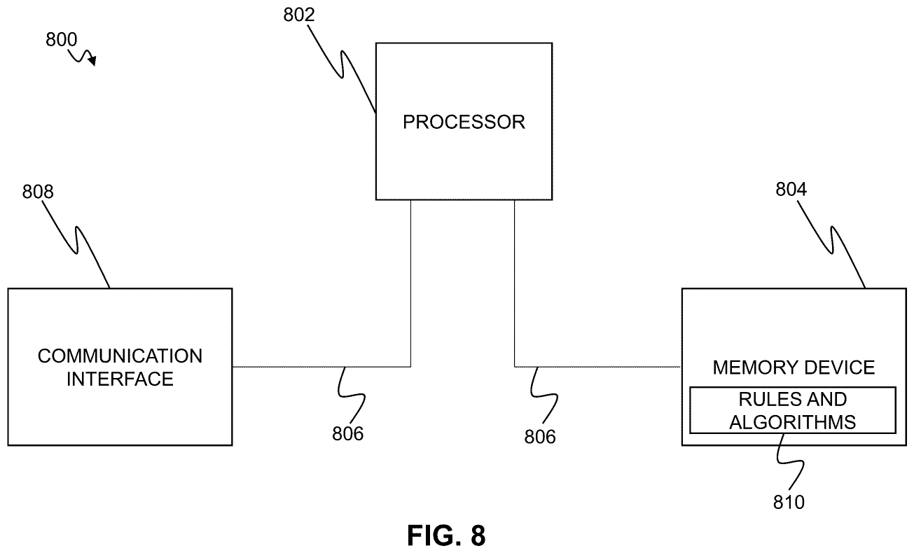

FIG. 8 is a block diagram illustrating an example configuration of a computing device 800 according to one embodiment of the present disclosure. Autonomy computing system 200 may be implemented with one or more computing devices 800. Computing device 800 includes a processor 802 and a memory device 804. Processor 802 is coupled to memory device 804 via a system bus 806. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, memory device 804 includes one or more devices that enable information, such as executable instructions or other data (e.g., sensor data), to be stored and retrieved. Moreover, memory device 804 includes one or more computer readable media, such as, without limitation, dynamic random access memory (DRAM), static random access memory (SRAM), a solid state disk, or a hard disk. In the example embodiment, the memory device 804 stores, without limitation, application source code, application object code, configuration data, additional input events, application states, assertion statements, validation results, or any other type of data. Computing device 800, in the example embodiment, may also include a communication interface 808 that is coupled to processor 802 via system bus 806. Moreover, communication interface 808 is communicatively coupled to data acquisition devices.

In the example embodiment, processor 802 may be programmed by encoding an operation using one or more executable instructions and providing the executable instructions in memory device 804. In the example embodiment, processor 802 is programmed to select a plurality of measurements that are received from data acquisition devices. In the example embodiment, rules and algorithms 810 are stored in memory device 804. Rules and algorithms 810 may include any/all of the rules and/or algorithms described herein.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

### MACHINE LEARNING & OTHER MATTERS

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

Some of the problems addressed herein include: inability of existing systems to (a) accurately determine the presence and/or properties of occluded objects, (b) accurately determine a correlation between an occluded object and a shadow corresponding to the occluded object, (c) accurately determine a correlation between emitted light and reflected light in a live driving session of an autonomous vehicle, (d) accurately perform tasks relating to detecting and characterizing occluded objects encountered by an autonomous vehicle in real-time during a live driving session; (e) accurately and safely control the operation of the autonomous vehicle based on real-time determinations made as to the occluded objects encountered by the autonomous vehicle; (f) accurately utilize environmental light sources to determine the presence and/or properties of occluded objects; and/or (g) accurately utilize dedicated light sources the presence and/or properties of occluded objects.

An example technical effect of the methods, systems, and apparatus described herein includes at least one of: (a) accurate determination and characterization of occluded objects based on measurements and determinations made from sensor data; (b) use of dedicated light sources to intentionally cause shadows and/or light reflections to occur in a live driving session of an autonomous vehicle; (c) accurate determination of properties and/or operational parameters of an occluded object based on analysis of a shadow corresponding to the occluded object; (d) accurate determination of a level of risk associated with an occluded object relative to operation of an autonomous vehicle in a live driving session; (e) update a travel path of an autonomous vehicle in real-time in accordance with a determination made as to whether an occluded object presents a risk to an autonomous vehicle; and (f) improve operational safety of an autonomous vehicle in real-time while driving in an environment where occluded objects may be present.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomous vehicle configured to detect occluded objects, the autonomous vehicle comprising:
at least one processor in communication with at least one memory device; and
one or more sensors, wherein the at least one processor is programmed to:
receive optical data of one or more optical phenomena adjacent the autonomous vehicle based upon analysis of sensor data from the one or more sensors of the autonomous vehicle;
analyze the optical data of the one or more optical phenomena to determine that the one or more optical phenomena corresponds to the presence of an object adjacent the autonomous vehicle, the object being occluded from a line of sight of the autonomous vehicle, the line of sight being defined at least in part by a trailer of the autonomous vehicle;
change one or more driving behaviors of the autonomous vehicle based upon the determination of the presence of the occluded object; and
control operation of the autonomous vehicle based upon the one or more changed driving behaviors.

2. The autonomous vehicle of claim 1, wherein the sensor data corresponds to sensing, by the one or more sensors, at least one of: (i) reflections of light from a natural source or (ii) reflections of light from an artificial source, and the at least one processor is further programmed to:
determine, based on the analysis of the sensor data, that the one or more optical phenomena includes a shadow corresponding to the occluded object.

3. The autonomous vehicle of claim 1, further comprising:
a light source; and
a mirror associated with the light source, wherein the one or more sensors includes one or more optical sensors and the at least one processor is further programmed to:
control the light source to emit light in a direction toward the mirror, the mirror being configured to direct light emitted from the light source in a direction toward the trailer as mirror-directed light;
receive reflection data associated with reflections of the mirror-directed light detected by the one or more optical sensors;
analyze the reflection data to determine properties of the occluded object; and
change the one or more driving behaviors based at least in part on the determined properties of the occluded object.

4. The autonomous vehicle of claim 3, wherein at least one of the light source or the mirror is movably connected to a portion of the autonomous vehicle, and the at least one processor is further programmed to:
transmit a control signal to adjust a position of the at least one of the light source or the mirror.

5. The autonomous vehicle of claim 1, further comprising:
a light source, wherein the one or more sensors includes one or more optical sensors, and the at least one processor is further programmed to:
control the light source to emit light in a direction toward the trailer;
receive reflection data associated with reflections of the emitted light detected by the one or more optical sensors;
analyze the reflection data to determine properties of the occluded object; and
change the one or more driving behaviors of the autonomous vehicle based at least in part on the determined properties of the occluded object.

6. The autonomous vehicle of claim 5, further comprising:
an extension device to which the light source is attached, wherein the at least one processor is further programmed to:
determine a target area to which the light source will be focused; and
control the extension device to move the extension device to a position such that light emitted from the light source will be directed to the target area in correspondence with the position of the extension device.

7. The autonomous vehicle of claim 5, wherein the light source is configured to emit light in a non-visible spectrum, and the reflection data includes data corresponding to reflections of non-visible emitted light sensed by the one or more optical sensors.

8. The autonomous vehicle of claim 1, wherein at least one sensor of the one or more sensors is movably connected to a body of the autonomous vehicle, and the at least one processor is further programmed to:
control the autonomous vehicle to execute a turn; and
control movement of the at least one sensor based on turn data associated with the execution of the turn such that the at least one sensor remains focused on a target area regardless of any change in direction of the body of the autonomous vehicle resulting from the execution of the turn.

9. An autonomy computing system of an autonomous vehicle for detecting occluded objects, the autonomy computing system comprising at least one processor in communication with at least one memory device, the at least one processor programmed to:
receive optical data of one or more optical phenomena adjacent the autonomous vehicle based upon analysis of sensor data from one or more sensors of the autonomous vehicle;
analyze the optical data of the one or more optical phenomena to determine that the one or more optical phenomena corresponds to the presence of an object adjacent the autonomous vehicle, the object being occluded from a line of sight of the autonomous vehicle, the line of sight being defined at least in part by a trailer of the autonomous vehicle;
change one or more driving behaviors of the autonomous vehicle based upon the determination of the presence of the occluded object; and
control operation of the autonomous vehicle based upon the one or more changed driving behaviors.

10. The autonomy computing system of claim 9, wherein the one or more sensors includes one or more optical sensors, and the at least one processor is further programmed to:
determine, based on the analysis of the optical data, that the one or more optical phenomena includes a shadow corresponding to the occluded object.

11. The autonomy computing system of claim 10, wherein the at least one processor is further programmed to:
analyze the shadow to determine characteristics of the shadow; and
determine at least one of a size or a shape of the occluded object based upon the determined characteristics of the shadow.

12. The autonomy computing system of claim 11, wherein the at least one processor is further programmed to:
determine a class of the occluded object based upon at least one of the determined size or the determined shape of the occluded object.

13. The autonomy computing system of claim 12, wherein the one or more driving behaviors includes a speed of the autonomous vehicle and the at least one processor is further programmed to:
determine, based at least upon the determined class of the occluded object, a distance between the occluded object and the trailer; and
change the speed of the autonomous vehicle to cause a change in the distance between the occluded object and the trailer.

14. The autonomy computing system of claim 10, wherein the one or more sensors includes a first set of optical sensors located at a first side of a body of the autonomous vehicle and a second set of optical sensors located at a second side of the body of the autonomous vehicle, and the at least one processor is further programmed to:
determine, one side at a time, and based upon the sensor data from the first set of optical sensors and the second set of optical sensors, whether the shadow of the occluded object is present on the first side of the autonomous vehicle or the second side of the autonomous vehicle.

15. The autonomy computing system of claim 9, wherein the one or more sensors includes one or more optical sensors and a light source, and the at least one processor is further programmed to:
control the light source to emit light in a direction toward the trailer;
receive reflection data associated with reflections of the emitted light detected by the one or more optical sensors;
analyze the reflection data to determine properties of the occluded object; and
change the one or more driving behaviors of the autonomous vehicle based at least in part on the determined properties of the occluded object.

16. The autonomy computing system of claim 9, wherein the one or more sensors includes one or more optical sensors, a light source, and a mirror, and the at least one processor is further programmed to:
control the light source to emit light in a direction toward the mirror, the mirror being configured to direct light emitted from the light source toward the mirror in a direction toward the trailer as mirror-directed light;
receive reflection data associated with reflections of the mirror-directed light detected by the one or more optical sensors;
analyze the reflection data to determine properties of the occluded object; and
change the one or more driving behaviors based at least in part on the determined properties of the occluded object.

17. The autonomy computing system of claim 9, wherein the at least one processor is further programmed to:
analyze the optical data to determine at least one of a location or a speed of the occluded object; and
change the one or more driving behaviors of the autonomous vehicle by controlling the autonomous vehicle to perform at least one of: a lane change, a speed change, an acceleration/deceleration change, or a braking maneuver.

18. The autonomy computing system of claim 9, wherein the at least one processor is further programmed to:
determine a current driving scenario of the autonomous vehicle; and
change one or more operating parameters of the one or more sensors based upon the detected current driving scenario, wherein the current driving scenario includes one of (i) the autonomous vehicle being operated to drive in a highway driving scenario and (ii) the autonomous vehicle being operated to drive in an intersection scenario.

19. The autonomy computing system of claim 9, wherein the occluded object is a vehicle, and the at least one processor is further programmed to:
determine, via at least the sensor data, that the vehicle is no longer occluded;
cease tracking of the vehicle as an occluded object; and
re-initiate tracking of the vehicle as an occluded object if the vehicle is subsequently determined to be occluded.

20. The autonomy computing system of claim 19, wherein the at least one processor is further programmed to generate an alert configured to provide external warning to one or more occupants of the vehicle of a change in the one or more driving behaviors of the autonomous vehicle.
